(19) United States
(12) Patent Application Publication
(10) Pub. No.: US 2015/0135438 A1
(43) Pub. Date: May 21, 2015

(54) OPERATING TABLE

(71) Applicant: Berchtold Holding GmbH, Tuttlingen (DE)

(72) Inventor: Silvio Marugg, Stetten (CH)

(21) Appl. No.: 14/540,584

(22) Filed: Nov. 13, 2014

(30) Foreign Application Priority Data
Nov. 18, 2013 (DE) 102013223486.4

(51) Int. Cl. A61G 13/04; A61G 13/06

(52) U.S. Cl. CPC A61G 13/04; A61G 13/06
USPC 5/608

(57) ABSTRACT

An operating table has a patient support having a longitudinal axis and a transverse axis, wherein the patient support is mounted on a column having a column head. A gimbal mounting is provided to pivot the patient support out of a horizontal basic position. The gimbal mounting can be elevated beyond the column head by a pivot device.

The present invention relates to an operating table which comprises a patient support which has a longitudinal axis and a transverse axis and which is mounted on a column which has a column head. A gimbal mounting is furthermore provided with which the patient support is pivotable from a horizontal basic position about its longitudinal axis and about its transverse axis.

Such operating tables are known from the prior art and are used as operating tables or examination tables in hospitals and in doctor's out-patient practices. In order in this respect to be able to bring the patient into a desired position, the patient support can be adjusted out of its horizontal basic position about its transverse axis (trend) and about its longitudinal axis (tilt). Pivot movements of 30% in the transverse axis and 20% in the longitudinal axis are typical here. Since, however, with modern operating tables, the axes of rotation trend and tilt are arranged more or less centrally with respect to the column, a complete combination of both movements is not always possible.

It is the object of the present invention to further develop an operating table in accordance with the preamble of claim 1 such that a large pivot range along both pivot axes of trend and tilt is possible with constructionally simple means.

This object is satisfied by the features of claim 1 and in particular in that a pivot device is provided which elevates the gimbal mounting beyond the column head. A larger spacing between the patient support and the column head is established by elevating the gimbal mounting so that larger pivot angles are possible. In accordance with the invention, the elevating of the patient support takes place by a pivot device which allows a constructionally simple and simultaneously stable solution which can be produced in an inexpensive manner. In this respect, the operating table in accordance with the invention is also suitable for heavyweight patients since the elevation of the gimbal mounting and of the patient support connected thereto is also possible with a heavy load with the aid of a pivot device.

Advantageous embodiments of the invention are described in the description, in the drawing and in the dependent claims.

In accordance with a first advantageous embodiment, the pivot device can have a pivot lever which is mounted at the column and which is pivotable about a stationary horizontal axis. A secure elevation and lowering of the gimbal mounting can be effected with the aid of such a pivot lever which can be produced inexpensively, but is stable. The stationary horizontal axis can in particular extend in parallel with the transverse axis of the patient support if it is in its horizontal basic position.

In accordance with a further advantageous embodiment, the pivot lever can be L-shaped. Such an L-shaped configuration provides the designer with additional degrees of freedom in that the space provided by the L can be otherwise used, for example by parts of a drive.

In accordance with a further advantageous embodiment, the gimbal mounting can have an external bearing part as a holder for the patient supports which is pivotably mounted at an internal bearing part which is in turn pivotally connected to the pivot device. The external bearing part can, for example, be frame-shaped and can receive the internal bearing part in its interior to obtain a compact bearing arrangement. It can be advantageous in this respect if the pivot device can at least be partly pivoted into the internal bearing part (and also into the external bearing part) since the maximum construction height of the total arrangement is hereby minimized.

In accordance with a further advantageous embodiment, the elevation of the gimbal mounting takes place only by a pivoting. Apart from the simple, but stable manner of construction already mentioned above, the control of the operating table is also hereby simplified since only a single drive has to be controlled for an elevation of the patient support, namely a drive for the pivot device.

In accordance with a further advantageous embodiment, a drive for a pivoting of the patient support about its longitudinal axis can be integrated into the gimbal mounting. A compact manner of construction is hereby additionally facilitated.

In accordance with a further advantageous embodiment, a drive can be provided with which the patient support is displaceable relative to the column in its longitudinal direction and preferably also independently of the pivot device. On the one hand, a longitudinal displacement of the patient support can be effected by such a drive without the pivot device having to be activated. On the other hand, on an activation of the pivot device, a displacement of the patient support can be effected by which a longitudinal displacement is compensated which is otherwise caused by the pivot movement. It can be advantageous for this purpose if a control is provided which controls the drive such that it compensates a translatory movement of the patient support effected by actuating the pivot device by a reverse movement. It is possible in this manner to elevate the patient support by a purely pivot movement without it carrying out a translatory movement in parallel with the horizontal.

In accordance with a further advantageous embodiment, two separate drives can be provided for a movement of the patient support about its transverse axis or about its horizontal axis.

The present invention will be described in the following purely by way of example with reference to an advantageous embodiment and to the enclosed drawings.

There are shown:

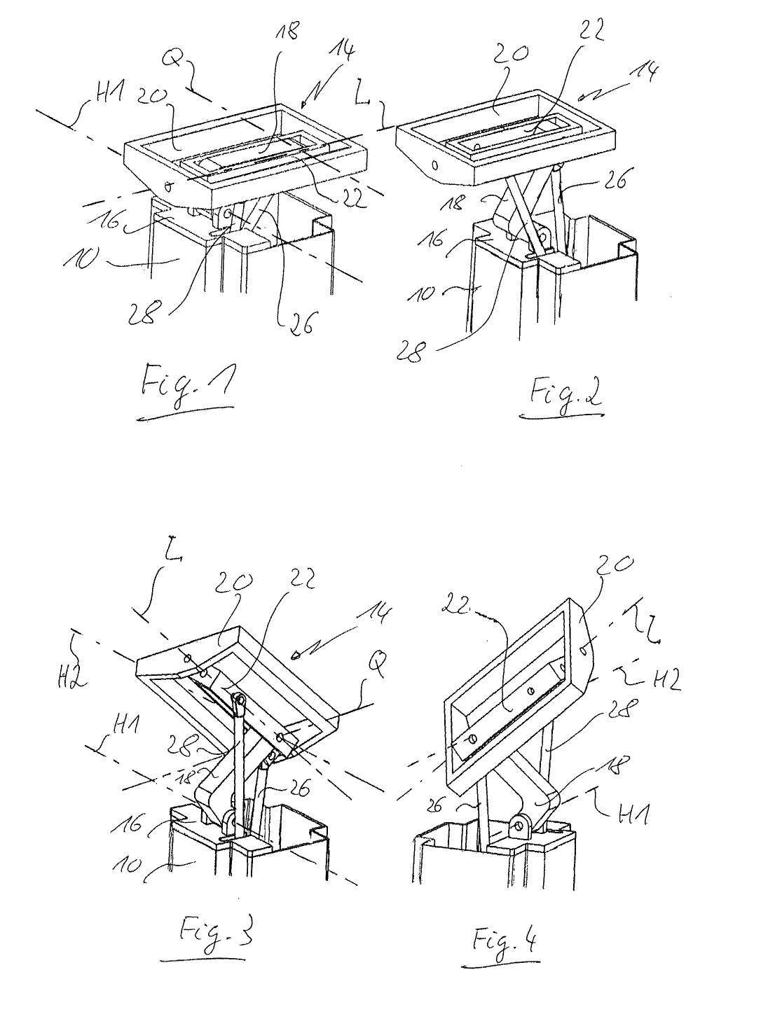

FIG. 1 a perspective part view of an operating table, with no patient support being shown:

FIG. 2 the representation of FIG. 1 with an elevated gimbal mount;

FIG. 3 the representation of FIG. 2, wherein the patient support (not shown) is pivoted about its longitudinal axis and about a horizontal transverse axis;

FIG. 4 a representation similar to FIG. 3;

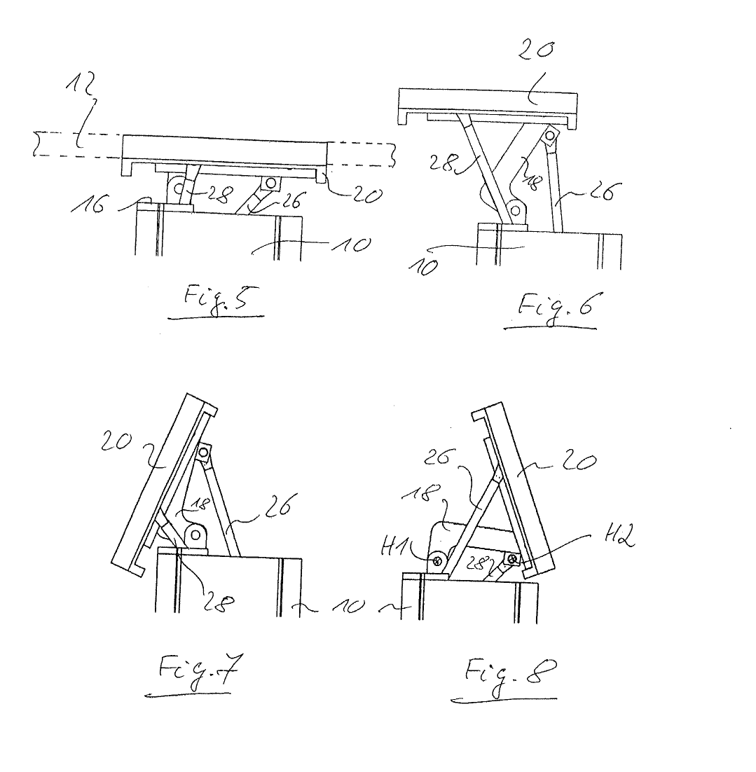

FIG. 5 a side view of the operating table of FIG. 1 to FIG. 4 with an indicated patient support;

FIG. 6 a representation similar to FIG. 5 with an elevated gimbal mounting:

FIG. 7 the representation of FIG. 6 in a maximum trend position: and

FIG. 8 the representation of FIG. 7 in a maximum reverse trend position.

FIG. 1 shows a perspective view of an operating table having a patient support 12 which is mounted on a column 10, but which is not shown in FIG. 1 for a simplified representation, but only in FIG. 5. The patient support has a longitudinal axis L and a transverse axis Q and is pivotable with the aid of a gimbal mounting 14 out of its horizontal basic position (FIG. 1 and FIG. 5) about its longitudinal axis L and about its transverse axis Q. In this respect, a pivoting about the transverse axis Q corresponds to a trend position and a pivoting about the longitudinal axis L corresponds to a tilt position of the patient support 12.

To elevate the gimbal mounting 14 out of its basic position shown in FIG. 1 (and in FIG. 5) beyond a column head 16 of the column 10, i.e. to increase the spacing between the patient support 12 or the gimbal mounting 14 and the column head 16, a pivot device is provided which elevates the gimbal mounting beyond the column head.

In the embodiment shown, the pivot device comprises an L-shaped pivot lever 18 which is mounted at the column 10 or at the column head 16 and which is pivotable about a stationary horizontal axis H1. The stationary horizontal axis H1, i.e. the horizontal axis fixedly connected to the column 10 of the column head 16, extends in parallel with the transverse axis Q of the patient support 12 in the horizontal basic position of the patient support 12.

As the Figures illustrate, the pivot lever 18 has a short lever arm and a long lever arm, wherein the short lever arm is pivotably mounted at the column head 16 and the long lever arm is pivotably connected at its outer end to the gimbal mounting 24. In the completely lowered position of the gimbal mounting 14, the long lever arm of the pivot lever 18 extends horizontally, whereas the short lever arm extends vertically. The pivotable connection between the pivot lever 18 and the gimbal mounting 14 takes place about a pivot axis H2 which extends horizontally at every point in time and which coincides with the transverse axis Q of the patient support in the horizontal basic position of the patient support 12.

The gimbal mounting 14 for the patient support 12 in the present embodiment comprises a frame-shaped external bearing part 20 as a holder for the patient support 12 which is pivotably mounted at a likewise frame-shaped internal bearing part 22, with the external bearing part 20 and the internal bearing part 22 being pivotable about the longitudinal axis L. The internal bearing part 22 is configured in this respect such that the long arm of the pivot lever 18 can be pivoted into the internal bearing part (cf. FIG. 1 and FIG. 5).

The elevation of the gimbal mounting 14 and thus also of the patient support 12 can take place only by a pivoting of the pivot lever 18 which is pivotally connected at its free end to a connecting rod 26 of a drive. Furthermore, a further connecting rod 28 is pivotably connected remote from the connection point between the internal bearing part 22 and the pivot lever 18 to allow a pivot movement of the internal bearing part 22 about the horizontal pivot axis H2. A drive (not shown) is integrated into the gimbal mounting 14 for a pivoting of the external bearing part 20 (and thus also of the patient support 12) about the longitudinal axis L. Furthermore, a drive (not shown) is provided with which the patient support 12 is displaceable relative to the column 10 in the longitudinal direction, i.e. in parallel with the axis L, and preferably independently of the pivot device.

The operation of the above-described operating table will be explained in the following.

In FIG. 1, the patient support 12 of the operating table is in its horizontal basic position in which the pivot axis Q extends in parallel with the pivot axis H1 and perpendicular to the longitudinal axis L. If an elevation of the patient support 12 is desired, the gimbal mounting can be elevated solely by moving out the connecting rod 26 beyond the column head 16, with the pivot lever 18 simultaneously being pivoted about the axis H1. In this respect, the internal bearing part 22 of the gimbal mounting 14 can be held in its horizontal position by a suitable control of the connecting rod 28. The resulting position is shown in perspective in FIG. 2 and in a side view in FIG. 6.

Starting from the horizontal basic position of FIG. 1 or FIG. 5, the patient support 12 can be pivoted into the maximum trend position shown in FIG. 7 in that the pivot lever 18 is pivoted as far as possible about the axis H1. Equally, the patient support 12 can be brought into the position of the maximum reverse trend in that the connecting rod 26 is moved out by a maximum and the external bearing part 20 is thereby pivoted by a maximum about the horizontal pivot axis H2, with the pivot lever 18 in this respect also still being able to be lowered with its long lever arm with the aid of the connecting rod 28.

FIGS. 3 and 4 illustrate that any desired combinations of trend and tilt are also possible. FIG. 3 thus illustrates a position of the patient support 12 or of the external bearing part in which the pivot lever 18 is pivoted upwardly so that the external bearing part 20 can be pivoted about the longitudinal axis 11 without a collision with the column 10 arising. In a similar manner, in the representation of

FIG. 4, the patient support 12 is pivoted both about its longitudinal axis L and about the horizontal pivot axis H2 at the free end of the pivot lever 18.

The patient support 12 can be adjusted with the control, not shown, either independently of a pivot movement of the pivot lever 18 in a longitudinal direction

L. It is also possible to carry out this translatory movement such that a translation of the patient support 12 effected by the pivot device is hereby compensated so that, on a movement of the gimbal mounting from the position shown in FIG. 1 into the position shown in FIG. 2, the corresponding movements are compensated so that the patient support does not carry out any translation in its horizontal basic position, but rather a purely raising movement.

1. An operating table comprising
a patient support, the patient support having a longitudinal axis, a transverse axis and being supported on a column, the column having a column head;
a gimbal mounting with which the patient support can be pivoted out of a horizontal basic position about the longitudinal axis and about the transverse axis; and
a pivot device, the pivot device elevating the gimbal mounting beyond the column head.

2. The operating table in accordance with claim 1,
in which the pivot device has a pivot lever, the pivot lever being mounted at the column and being pivotable about a stationary horizontal axis.

3. The operating table in accordance with claim 1,
in which the stationary horizontal axis extends in parallel with the transverse axis of the patient support when the patient support is in the horizontal basic position.

4. The operating table in accordance with claim 2,
in which the pivot lever is L-shaped.

5. The operating table in accordance with claim 1,
in which the gimbal mounting has an external bearing part as a holder for the patient support, the external bearing part being pivotably connected to an internal bearing part, the internal bearing part being pivotably connected to the pivot device.

6. The operating table in accordance with claim 5,
in which the pivot device can be pivoted at least partly into the internal bearing part.

7. The operating table in accordance with claim 1,
in which the elevation of the gimbal mounting takes place solely by a pivoting.

8. The operating table in accordance with claim 1,
further comprising a drive for a pivoting about the longitudinal axis, the drive being integrated into the gimbal mounting.

9. The operating table in accordance with claim 1,
further comprising a drive to displace the patient support relative to the column in the longitudinal direction.

10. The operating table in accordance with claim 9,
in which the drive displaces the patient support relative to the column in the longitudinal direction independently of the pivot device.

11. The operating table in accordance with claim 9,
further comprising a control to control the drive such that it compensates a translatory movement of the patient support effected by an actuation of the pivot device by a reverse compensation movement.

12. The operating table in accordance with claim 1,
further comprising two separate drives for a movement of the patient support about the transverse axis.
